(19) United States
(12) Patent Application Publication
(10) Pub. No.: US 2017/0159855 A1
(43) Pub. Date: Jun. 8, 2017

(54) WATER-TIGHT CONDUIT FITTING

(71) Applicant: Junjie HUANG, FUZHOU (CN)

(72) Inventor: Junjie HUANG, FUZHOU (CN)

(21) Appl. No.: 15/393,588

(22) Filed: Dec. 29, 2016

Related U.S. Application Data
(60) Provisional application No. 62/354,558, filed on Jun. 24, 2016.

(51) Int. Cl. F16L 19/065; H02G 3/06; H02G 3/04

(52) U.S. Cl. CPC F16L 19/065; H02G 3/0406; H02G 3/06

(57) ABSTRACT

1. An apparatus, device, method, and system for fitting a pipe or other type of conduit, that may comprise an integrated watertight ring having an outer surface and an inner surface that are integrated into one piece for the purpose of installation, and wherein the inner surface is an elastomer. As the integrated watertight ring is tightened during installation, the inner surface preferably squeezes together for form a water-tight seal. For this purpose, it may be preferable for the inner surface of the integrated water-tight ring to be an elastomer such as, but not limited to, rubber, polybutadiene, polyisobutylene, and/or other polyurethanes. It may also be preferable for the integrated watertight ring to be a single-piece ring made of a combination of a rigid material and a compressible material that forms a seal when compressed. For ease of installation, it may be preferable for the integrated water-tight ring to be open ended for sliding the integrated water-tight ring over the conduit and/or base of the fitting, and later squeezed together by tightening a gland nut or other similar compression device as is known to those skilled in the relative arts.

### CROSS REFERENCE TO RELATED APPLICATIONS

This application claims priority to U.S. provisional application Ser. No. 62/354,558, filed Jun. 24, 2016, the entire contents of which is incorporated herein.

### BACKGROUND OF THE INVENTION

1. Technical Field

The invention disclosed herein relates to building materials. In particular, this device relates to pipe and other conduit materials for, by way of non-limiting example, running electrical wires.

2. Related Art

This patent draws from and improves upon U.S. Pat. Nos. 2,473,419, 2,651,529, 6,939,160, 7,080,859, 7,604,261, as well as U.S. patent application Ser. Nos. 10/697,223. All of these patents are incorporated in their entirety, herein, as are the applications they cite.

Coupling devices are commonly used to connect two or more conduits containing electrical cables and/or wires. Prior art coupling devices for a pair of conduits are generally tubular, with threaded opposite ends for receiving the conduit. Many prior art devices have sought to prevent rain water, ground water, and other fluids from entering the conduit and creating electrical and corrosion problems. However, such prior art coupling devices allow moisture or rain to eventually seep through the threading past the seal, causing corrosion or short-circuit of the electrical cables and/or wires.

An additional disadvantage found in the prior art arises during installation. Typical rain-tight fittings in the prior art treat the seal and the compression ring as individual pieces. For example, the above cited patent application No. 697,223 by Shemtov includes a sealing washer 14, 114, and friction washer 16, that are “sealed” by compression washer 118.

Generally, to install a pipe into an assembly, the gland nut needs to be disassembled and put on the pipe first. The compression ring and seal need to be placed on the pipe separately before the pipe is pushed into the assembly, then the gland nut needs to be fastened to complete the installation. This is labor intensive work, which also takes time to complete.

Therefore, there is a need for a coupling device that effectively provides a rain tight seal around a conduit and facilitates quick coupling of a conduit.

### SUMMARY

Disclosed is an apparatus and system that provides a rain-tight seal on a pipe or other conduit. Importantly, as used herein the words ‘pipe’ and ‘conduit’ are used interchangeably; however, the word ‘conduit’ includes a pipe as well as other conduits as understood by one skilled in the art, while the word ‘pipe’ is a type of conduit, representative of one preferred embodiment, but by no means the only embodiment. Herein, the broader term always applies. In addition, because the goal of the invention is to prevent any undesirable substances from breaching the defense provided by the conduit and compromising its contents, and because such prevention may never be 100% fool-proof, all use of the terms ‘prevention’ and ‘prevent’ and their synonyms are for our purposed defined to include ‘substantial prevention’ and ‘attempted prevention’.

Examples of conduits within the scope of the invention are electrical wires, hoses, and any other conduit as understood by one skilled in the related arts. In fact, all examples in the present application are non-limiting examples unless otherwise stated.

A conduit fitting assembly is disclosed herein which may comprise a fitting body configured to accept a conduit, an integral watertight band, and a gland nut configured to compress the integral watertight band between the conduit and the fitting so as to create a watertight seal between the conduit and the fitting when tightened so as to protect the contents of the conduit.

In another embodiment, we might have a conduit fitting assembly wherein an integral watertight band further comprises an inner surface that is, by way of non-limiting example, an elastic sealant band and a rigid outer surface that is a compression ring.

Additionally, the sealant band and the compression ring might have split ends, such that the ends of the ends of each are open until compressed, when they squeeze together. For example, the split ends of the sealant band are configured to match with each other and compress to create a watertight seal. The split ends of the sealant band may also be thicker than the rest of the sealant band and protrude radially outward as to exist between the split ends of the compression band and squeeze together as the gland nut tightens and compresses the compression band.

For ease of installation, it may be preferable for the integrated water-tight ring to be open ended for sliding the integrated water-tight ring over the conduit and/or base of the fitting, and later squeezed together by tightening a gland nut or other similar compression device as is known to those skilled in the relative arts.

In one embodiment, the sealant band is made of an elastomer, such as rubber, polybutadiene, polyisobutylene, and other polyurethanes, for example.

By way of non-limiting example, watertight might include rainwater and/or any other fluid. Also by way of non-limiting example, the conduit might be a pipe that preferably contains electrical wires or the like as would be known to those skilled in the art of building and construction, and arts related thereto.

Also disclosed herein is a method for creating a watertight seal between a fitting and a conduit comprising that preferably comprises inserting a conduit into a fitting having a fitting base, gland nut, and integral watertight ring, tightening the gland nut, preferably thus compressing the integrated watertight ring between the gland nut and the conduit preferably so as to create a watertight seal, and preferably thus protecting the contents of the conduit. The method may of course include, but not limited to, all of the above examples.

Preferably, the integrated watertight ring can further comprise a sealant band and a compression ring that are attached to each other so that when tightening the gland nut, the sealant band may squeeze (or ‘squish’) together as the compression band compresses as a result of the tightening. By way of non-limiting example, it might be preferable to provide an integrated watertight band with the outer surface of the sealant band attached to the inner surface of the compression band with an adhesive. The adhesive may be, by way of non-limiting example, glue or other appropriate epoxy.

As mentioned, the sealant band may be made of an elastomer, such as rubber, polybutadiene, polyisobutylene, and polyurethanes.

The method might also comprise providing matching split ends on the compression ring and sealant band. Additionally, the split ends of the sealant band might be thicker than the rest of the sealant band and might protrude radially outward as to exist between the split ends of the compression band and may squeeze together as the gland nut tightens and compresses the compression band.

Perhaps another embodiment is a watertight fitting assembly comprising a fitting base configured to accept a pipe, a gland nut also configured to accept the pipe and to mate with the fitting base, and a means for creating a watertight seal between the pipe and the fitting assembly when the gland nut is tightened onto the fitting base. Such means-for can include any single-part item disclosed herein which may compress in order to form a water-tight seal between the pipe and fitting, such as a ring that, while rigid enough to maintain shape, also comprises an inner surface capable for forming a seal around the pipe preferably to prevent water from entering the conduit. Said inner surface may, by way of non-limiting example, be a sealant that could be, for example, an elastomer or other sealant known to those skilled in the related arts.

Another watertight fitting assembly may present a means for creating a watertight seal between the pipe and the fitting assembly when the gland nut is tightened onto the fitting base that could be a watertight ring configured to fit between the pipe and the fitting. The watertight ring could have an elastic inner surface attached to a rigid outer surface. The outer surface of the watertight ring might compress so that as the gland nut is tightened the inner surface squeezes together as the outer surface compresses, preferably creating a watertight seal that protects the contents of the pipe.

In another embodiment and method using the same includes a integral watertight ring that may be a single piece that comprises a rigid material mixed with a compressible material configured to form a seal, such as a watertight seal, when compressed.

Simple embodiments can exist where a system for fitting a conduit might comprise an integral watertight ring having an outer surface and an inner surface, and wherein the inner surface is an elastomer, integrated preferably so as to eliminate the need for a locking/compression ring separate from the sealant band.

### BRIEF DESCRIPTION OF THE DRAWINGS

The disclosure may be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is an embodiment of an integral watertight pipe fitting assembly.

FIG. 2 is an exploded depiction of an integral watertight pipe fitting assembly.

FIG. 3A is an open embodiment of an integral watertight ring with triangular, protruding ends.

FIG. 3B is a closed embodiment of an integral watertight ring with triangular, protruding ends.

FIG. 3C is an exploded depiction of an embodiment of an integral watertight ring.

FIG. 4A is an open embodiment of an integral watertight ring with jagged, protruding ends.

FIG. 4B is a closed embodiment of an integral watertight ring with jagged, protruding ends

FIG. 4C is another exploded depiction of an embodiment of an integral watertight ring.

FIG. 5 is another embodiment of an exploded integral watertight pipe fitting assembly.

FIG. 6 is another embodiment of an exploded integral watertight pipe fitting assembly.

FIG. 7 is a closed embodiment of a single-piece watertight ring.

FIG. 8 is another embodiment of an exploded integral watertight pipe fitting assembly.

FIG. 9 is an open embodiment of a single-piece watertight ring.

### DETAILED DESCRIPTION OF THE PREFERRED EMBODIMENTS

While the invention has been shown and described with reference to a particular embodiment or embodiments thereof, it will be understood to those skilled in the art that various changes in form and details may be made therein without departing from the spirit and scope of the invention.

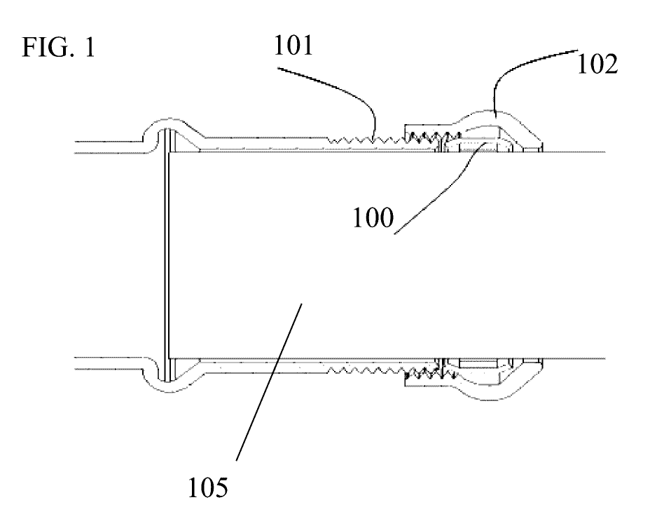

FIG. 1 depicts a cross-section view of an embodiment of a rain-tight fitting assembly wherein conduit 105 is housed by a fitting. Conduit 105 may be used to traverse a fluid such as but not limited to water, wires, gases or other substance required for the broad arts of construction, building, landscaping, and town planning and building.

The fitting comprises fitting body 101, gland nut 102, and integral watertight ring 100. As depicted, integral watertight ring 100 rests atop fitting body 101, and gland nut 102 secures integral watertight ring 100 by screwing into fitting body 101.

In one embodiment, integral watertight ring 100 can rest securely between the conduit 105 and gland nut 102. In other embodiments, integral watertight ring 100 may rest between gland nut 102 and fitting body 101. Integral watertight ring 100 will be discussed in much more detail, below.

In one example, fitting body 101 and gland nut 102 mate using threads although many more ways to attach gland nut 102 and fitting body 101 are known to one skilled in the related arts.

Finally, despite being called ‘watertight,’ integral watertight ring 100 is meant to include any such fluid or gas known to one skilled in the art at the time of invention that may be desirable to attempt to prevent or substantially reduce from entering conduit 105.

In all remaining figures, integral watertight ring 100 can be depicted in an exploded, or separated view. This is done for purposes of instruction and explanation herein only. Unless otherwise specified, the parts that make up integral watertight ring 100 are integral to each other; they are physically attached to be one piece.

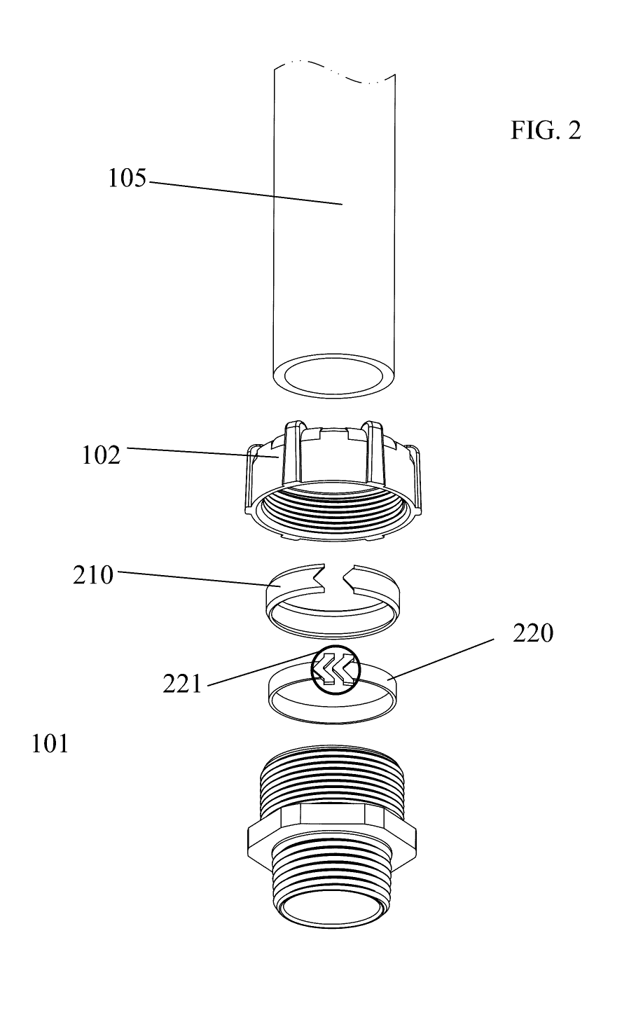

In FIG. 2 of the drawings, we have an exploded illustration of a watertight assembly for fitting a conduit 105 into a fitting comprised of a gland nut 102 and a fitting base 101. Also depicted is a compression ring 210 and a sealant band 220. It is preferable to have the weatherproofing integrated into the compression ring 210 so that during use the fitting assembly need not be disassembled; a conduit 105 such as a pipe can be directly thrust into the assembly and the gland nut 102 tightened to complete installation. This is a labor saving and time saving embodiment of the invention.

Compression ring 210 fits over sealant band 220 such that the inner surface of the compression band 210 is attached to the outer surface of the sealant band 220. The sealant band 220 and the compression ring 210, together, are integral to each other and form integral watertight ring 100. To be clear, FIG. 2 provides us with an exploded view one embodiment of an integral watertight ring 100 and are not, in fact, separate parts. The user of the invention will place the integral watertight ring 100 into place as one piece, and in one step, although embodiments exist where a user skilled in the related arts might separate the integral watertight ring 100 into its further components. Integral watertight ring 100, compression ring 210, and sealant band 220 will be discussed in detail in the next drawings.

FIG. 2 also depicts a sealant band 220 with matching ends 221. In this embodiment, matching ends 221 are triangular shaped so as to fit snuggly together. In a preferred embodiment, the matching ends 221 of the sealant ring 220 are uniquely shaped to fit with the ends of compression ring 210 so that a watertight seal is formed at the ‘split’ ends of the compression ring 210 after the gland nut 102 is tightened.

As depicted, matching ends 221 are raised so as to protrude radially outward from the ends of the compression ring 210 and will preferably squish together to provide additional waterproofing. However, it is within the scope of the invention to have matching ends 221 not raised, flush with the rest of the sealant band 220, and which end at or before reaching the end of the compression ring 210 and do not protrude radially outward from compression ring 210.

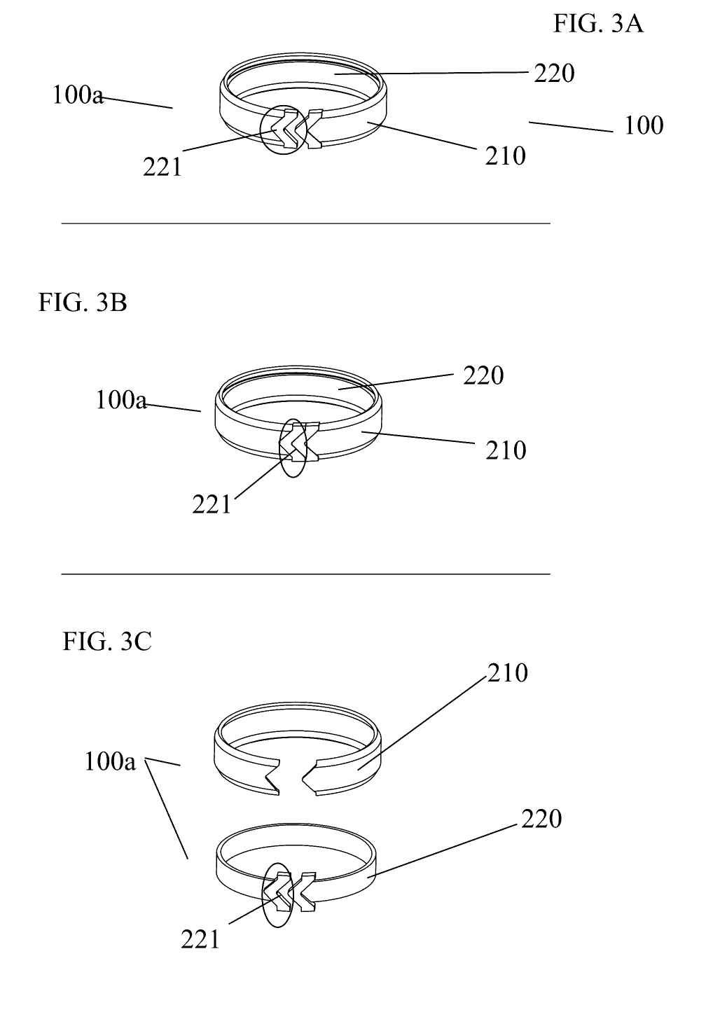

Having discussed the broad nature of the invention, we now turn to FIGS. 3A-3C.

FIG. 3A depicts one embodiment of a integral watertight ring 100. As can be seen, integral watertight ring 100a is a integral watertight ring 100 that comprises two main parts: compression ring 210 and sealant band 220 with triangular matching edges 221. As in FIG. 2, the matching edges 221 of sealant band 220 are raised so as to protrude radially outward and above compression ring 210. Embodiments with matching edges 221 flush with the rest of the integral watertight ring 100, 100a exist, and are in some cases preferable, as would be understood by one skilled in the related arts.

In this embodiment, compression ring 210 is made of a rigid material such as, but not limited to metal, plastic, or other substance or polymer known to one skilled in the art. Compression ring 210 is not so rigid as to prevent it from closing so as to provide a watertight seal between its ends. Whether the ends of the compression ring 210 touch each other when closed depends on whether a raised portion of the matching ends 221 protrude radially outward so as to prevent compression ring 210 from closing fully when compressed. Embodiments with compression ring 210 compressing fully so as to have its ends touch can be just as preferable, less preferable, and more preferable than embodiments where the ends of compression ring 210 do not touch when fully compressed; this is because of the nature having matching ends 221 protrude so as to prevent full compression of compression ring 210. This can all be seen more clearly in FIG. 3B.

Outer surface of the sealant band 220 is preferably attached to the inner surface of the compression ring 210 with an adhesive, such as but not limited to glue or another epoxy, so that integral watertight ring 100a is used as one piece. It is also preferable that sealant band 220 be made of a material that is naturally adhesive so it ‘sticks’ to the inner surface of the compression ring 210 naturally, or possibly with the addition of another substance, such as water, air or other catalyst as would be known to one skilled in the related arts. In some embodiments, sealant band 220 is made of an elastic seal such as rubber or elastomer, or other substance known to one skilled in the art.

The nature of the seal is produced by the sealant band 220 in that the elasticity of the sealant band 220 material allows the matching ends 221 of the sealant band 220 to come together by ‘squishing’ so as to form a watertight seal. Meanwhile, the nature of the compression ring 210 is to form the backbone of the open (FIG. 3A) or closed (FIG. 3B) integral watertight ring 100a. In some instances it might be preferable to imagine the integral watertight ring 100a as elastic (sealant band 220) with a rigid outer surface, or backbone (compression ring 210); and in other instances it might be preferable to imagine the integral watertight ring 100a as more rigid (compression ring 210) with an elastic inner surface (sealant band 220). Either way, at the time of installation integral watertight ring 100, 100a, 100b is one part.

It should be noted that it is preferable but not necessary for the matching ends 221 to match the shape and size of compression ring 210. In FIGS. 2, 3A, 3B, and 3C matching ends 221 are triangularly shaped but the shape, length and size of the protrusion of the matching ends 221 could vary as is preferable to one skilled in the related arts. Further, the material making up matching ends 221 are preferably of the same material that makes up the sealant band 220, though one skilled in the art would understand it might be preferable to make the matching ends 221 of a separate material for more or less elasticity as desired.

FIG. 3C is an exploded view of integral watertight ring 100a as separated, yet comprising an inner, more elastic inner band called the sealant band 220 and a more rigid outer band called the compression ring 210, both integral to each other. As would be understood by one skilled in the art, it may be preferable to have the sealant band 220 the outer band with the compression ring as the inner band. For the purposes of this patent, the relation of an outer band and inner band is that the outer surface of an inner band is attached in a permanent or semi-permanent way to the inner surface of the outer band.

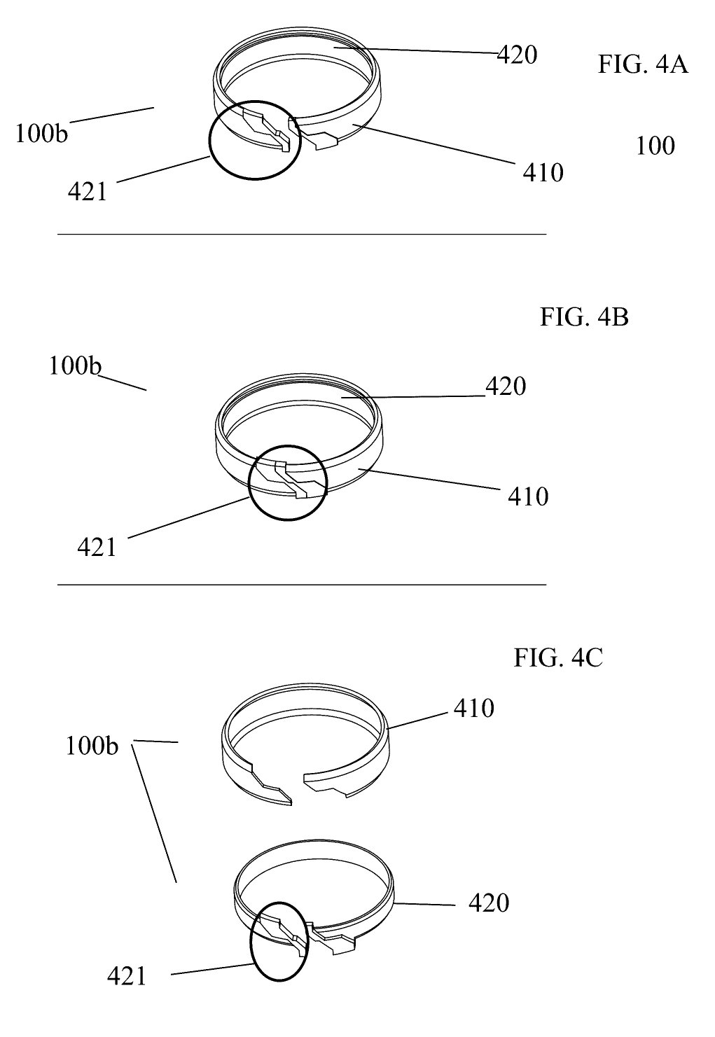

FIGS. 4A-4C depict a integral watertight ring 100b comprising matching ends 421 with a jagged shape. Also depicted are matching ends 421 that are barely protruding radially outward from the sealant band 420 and are flush or close to flush with compression ring 410. Aside from these differences, the FIG. 4 embodiments are identical to the FIG. 3 embodiments and everything in the detailed descriptions of FIGS. 3A, 3B, and 3C correspond and apply to a description of FIGS. 4A, 4B, and 4C, respectively. In some instances one might be preferred over the other as would be understood by one skilled in the related arts. It bears repeating that matching ends 221, 421 with triangular or jagged edged shapes, or flush or protruding matching ends 421, 221, are meant to serve as non-limiting examples of matching ends 221, 421 as many other configurations remain within the scope of the claimed invention, as would be understood by one skilled in the related arts.

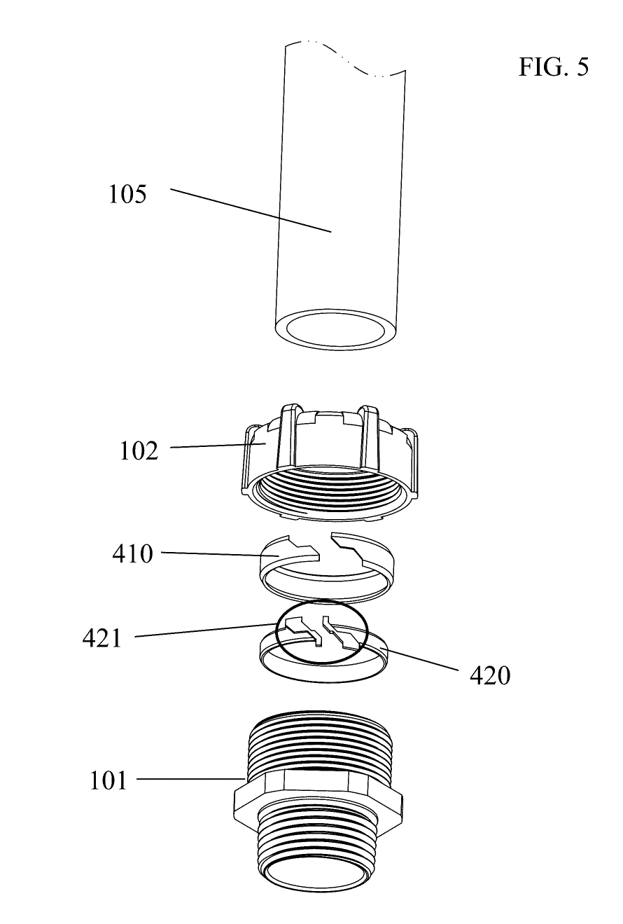

Lastly, FIG. 5 attempts to illustrate one embodiment of the assembly with integral watertight ring 100b, compression ring 410, and sealing ring 420, with corresponding numbering for corresponding parts.

In all FIGS. 1-5, sealant band 220, 420 and compression ring 210, 410 may preferably be attached together by any adhesive means known to one skilled in the art. Additional adhesive or epoxy for the purpose of helping to bond the integral watertight ring 100 to another part, such as a fitting base 101, gland nut 102, conduit 105, or other part may be applied to a portion of the sealant band 220, 440, compression ring 210, 410 or both, as would be known to one skilled in the art.

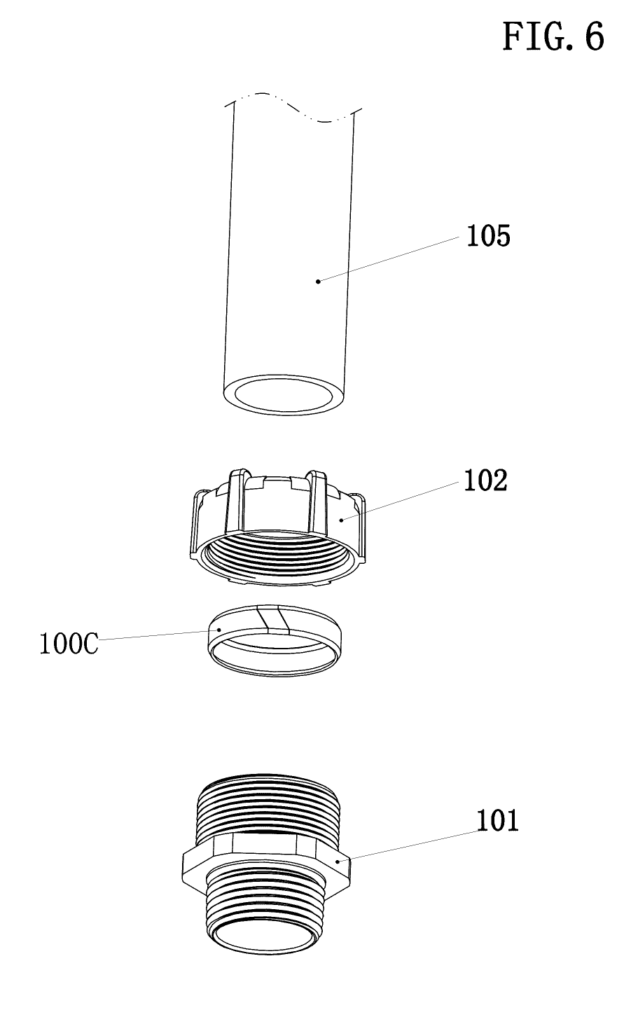

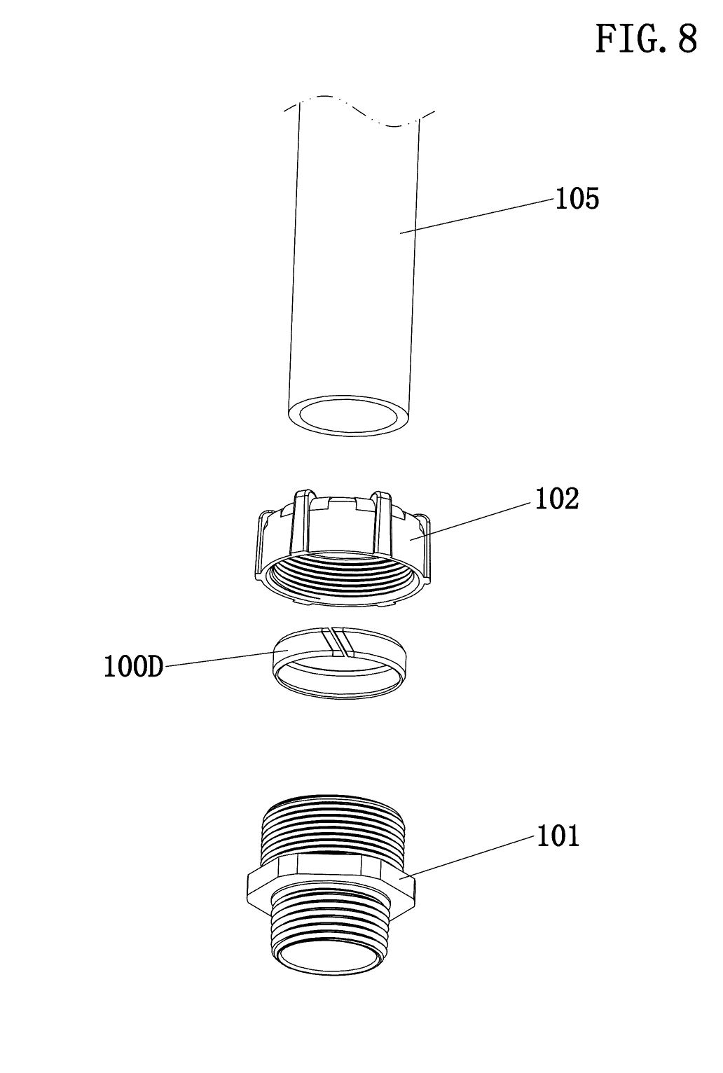

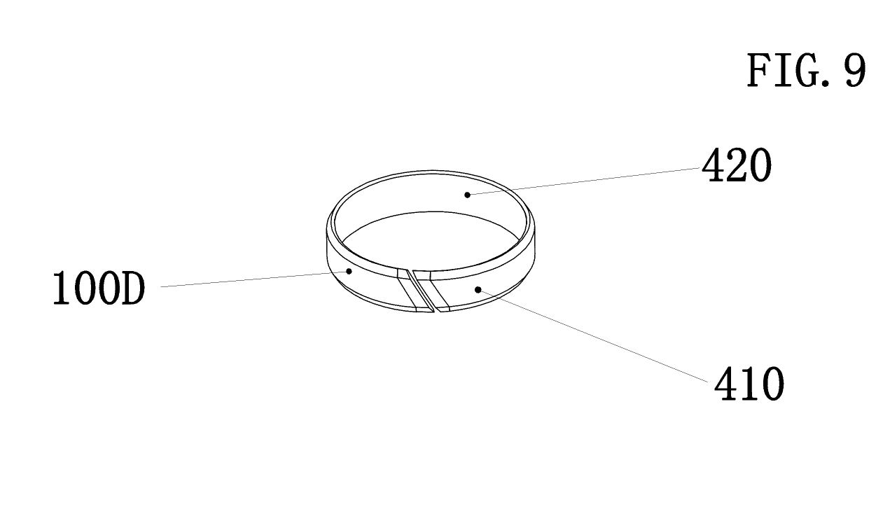

FIGS. 6 and 8 depict embodiments of the invention where we have an exploded illustration of a watertight assembly for fitting a conduit 105 into a fitting comprised of a gland nut 102 and a fitting base 101. However, in this depiction we have single-piece watertight rings 100C and 100D, respectively. Single-piece watertight rings 100C, 100D are intermixtures of a compression ring 210/410 and sealant band 220/420, as will be discussed below. The difference between single-piece watertight rings 100C and 100D is that single-piece watertight ring 100C is a closed loop and single-piece watertight ring 100D is an open loop. This can be seen more clearly by looking at FIG. 9.

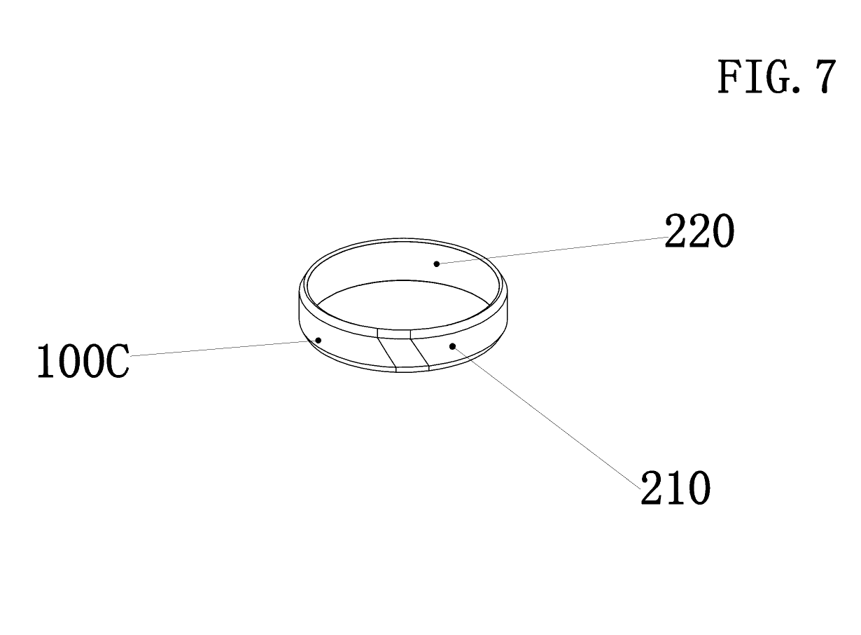

One example of single-piece watertight ring 100C can be seen in FIG. 7. Single-piece watertight ring 100C is one element and includes a mixture, or “mash-up” of both a compression ring 210 and a sealant band 220. This single ring preferably includes the rigidity of the compression ring 210 and the waterproofing material of sealant band 220.

In this example, the rain tight function can be achieved by squeezing single-piece watertight ring 100C. By way of non-limiting example, FIG. 7 depicts a single-piece watertight ring 100C is a closed loop with elements of sealant band 220 on the inner surface and elements of compression ring 210 on the outer surface. It is important to note, however, that the intermixture of compression ring 210 and sealant band 220 need not be so tidy: it might be preferable that elements of compression ring 210 and sealant band 220 be intermingled so that one appears on the outside and the other in the inside in an alternating pattern, a swirl pattern, or any other pattern that makes sense to one skilled in the art and/or makes sense for the machining process when making single-piece watertight ring 100C. Preferably, when the user screws gland nut 102 on to the assembly, the single-piece watertight ring 100C, 100D compresses, allowing a waterproof seal to be created. In such an example, the rigid element of single-piece watertight right ring 100C, 100D will maintain the its desired shape and guide the sealant material to appropriately fill in any spaces so that a watertight seal is created—just like when integral watertight ring 100 was comprised of two bands, compression ring 210 and sealant band 220. The difference in these latter examples is that only one band is necessary.

While various embodiments of the invention have been described, it will be apparent to those of ordinary skill in the art that many more embodiments and implementations are possible within the scope of the invention. The various embodiments described herein include a variety of materials, hinges, attachment members, and methods of securing, swinging, and closing. The described example configurations of elements and methods are examples that may be embodied through equivalent configurations having additional or fewer of the described elements, systems, devices, and methods, alternative elements, materials, systems, devices, and methods within the scope of invention. Accordingly, the invention is not to be restricted except in light of the attached claims and their equivalents.

We claim:

1. A conduit fitting assembly comprising:
a fitting body configured to accept a conduit,
an integral watertight ring, and
a gland nut configured to compress the integral watertight ring between the conduit and the fitting so as to create a watertight seal between the conduit and the fitting when tightened so as to protect the contents of the conduit.

2. The assembly of claim 1 wherein the integral watertight ring further comprises an inner surface that is an elastic sealant band and a rigid outer surface that is a compression ring.

3. The assembly of claim 2 wherein the sealant band and the compression ring have split ends.

4. The assembly of claim 3 wherein the split ends of the sealant band are configured to match with each other and compress to create a watertight seal.

5. The assembly of claim 4 wherein the split ends of the sealant band are thicker than the rest of the sealant band and protrude radially outward as to exist between the split ends of the compression band and squeeze together as the gland nut tightens and compresses the compression band.

6. The assembly of claim 2 wherein the sealant band is made of an elastomer, such as rubber, polybutadiene, polyisobutylene, and polyurethanes .

7. The assembly of claim 1 wherein watertight includes rainwater and any other fluid.

8. The assembly of claim 1 wherein the conduit is a pipe.

9. A method for creating a watertight seal between a fitting and a conduit comprising:
inserting a conduit into a fitting having a fitting base, gland nut, and integral watertight ring,
tightening the gland nut, thus
compressing the integrated watertight ring between the gland nut and the conduit so as to create a watertight seal, thus protecting the contents of the conduit.

10. The method of claim 9 wherein the integrated watertight ring further comprises a sealant band and a compression ring that are attached to each other so that when tightening the gland nut, the sealant band squeezes together as the compression band compresses as a result of the tightening.

11. The method of claim 10 further comprising:
providing an integrated watertight ring with the outer surface of the sealant band attached to the inner surface of the compression band with an adhesive.

12. The method of claim 10 wherein the sealant band is made of an elastomer, such as rubber, polybutadiene, polyisobutylene, and polyurethanes.

13. The method of claim 10 further comprising:
providing matching split ends on the compression ring and sealant band.

14. The method of claim 13 wherein the split ends of the sealant band are thicker than the rest of the sealant band and protrude radially outward as to exist between the split ends of the compression band and squeeze together as the gland nut tightens and compresses the compression band.

15. A watertight fitting assembly comprising:
a fitting base configured to accept a pipe,
a gland nut also configured to accept the pipe and to mate with the fitting base, and
a means for creating a watertight seal between the pipe and the fitting assembly when the gland nut is tightened onto the fitting base.

16. The watertight fitting assembly of claim 15, wherein the means for creating a watertight seal between the pipe and the fitting assembly when the gland nut is tightened onto the fitting base comprises:
a watertight ring configured to fit between the pipe and the fitting, the watertight ring having an elastic inner surface attached to a rigid outer surface, and wherein the outer surface of the watertight ring compresses as the gland nut is tightened and the inner surface squeezes together as the outer surface compresses, creating a watertight seal that protects the contents of the pipe.

17. A system for fitting a conduit comprising a watertight ring having an outer surface and an inner surface that are integrated into one piece for the purpose of installation, and wherein the inner surface is an elastomer.

18. The assembly of claim 1 wherein the integral watertight ring comprises a rigid material mixed with a compressible material configured to form a seal when compressed.

19. The assembly of claim 1 wherein the integral watertight ring comprises a rigid material mixed with a compressible material configured to form a watertight seal when compressed.

20. The method of claim 9 wherein the integral watertight ring is a single band comprising a rigid material interspersed with a compressible material configured to form a watertight seal when compressed.
